(19) United States
(12) Patent Application Publication
(10) Pub. No.: US 2008/0133562 A1
(43) Pub. Date: Jun. 5, 2008

(54) CODING COMPRESSIBLE VARIABLE LENGTH DATABASE FIELDS

(76) Inventors: Chi Ping Bess Cheong, Escondido, CA (US); Michael Reed, San Diego, CA (US); May Pederson, San Diego, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/566,768

(22) Filed: Dec. 5, 2006

(51) Int. Cl. G06F 7/00

(52) U.S. Cl. 707/101

(57) ABSTRACT

A method, computer program, database system and data structure for coding a compressible variable length field in a row to be added to a database table are disclosed. The row has a value to be stored in the compressible variable length field. The value is searched for in a list of values for the compressible variable length field stored in the table. IF the value is found in the list of values, the row is created in the table with a first code associated with the value, a second code associated with a location in the row, but without the compressible variable length field. Otherwise, the row is created in the table with the value stored in the compressible variable length field, a first code indicating that the value is stored in the row, and a second code associated with the location of the value in the row.

### BACKGROUND

Database systems typically include tables, each of which includes a set of rows, which are frequently divided into fields (or columns). The information in some fields may not be unique from row to row. For example, in a database that contains the addresses of all the residents of the United States, “New York,” “Los Angeles,” and “Chicago” would appear frequently in a “city” field. This repetition in a field from row to row can be the basis for compressing the field.

Some columns in database systems are fixed lengths, for example date columns, but other columns maybe variable lengths. One example of a variable length column is a column that stores country names. Country names vary in length form relatively short names such as “Chad” or “Mali” to long names such as “South Georgia and the South Sandwich Islands”. Storing country names in a field of type variable character uses less storage space than a fixed length field of say 50 characters. Previous systems, for example the Applicant's patent application Ser. No. 10/321,805 Coding Compressible Database Fields, describe compression for fixed length database fields.

### SUMMARY

In general in one aspect, the invention features a method for coding a compressible variable length field in a row to be added to a database table. The row has a value to be stored in the compressible variable length field. The method includes searching for the value in a list of values for the compressible variable length field stored in a table. If the value is found in this list of values, the row is created in the table with a first code associated with the value and a second code associated with a location in the row but without the compressible variable length field. Otherwise the row is created in the table with the value stored in the compressible variable length field at a location in the row. The first code indicating that the value is stored in the row and a second code associated with the location of the value in the row.

Implementations of the invention may include one or more of the following. Searching for the value may include reading the first code, if the first code indicates the value is in the list of values, searching for the value in a list of values for the compressible variable length field stored in the table header. The method may include creating the list of values for the compressible variable length field within the table and associating a first code with each of the values in the list of values. The list of values may include T values and associating a code with each of the values in the list of values may include assigning a unique code to each of the T values.

The method may further include creating a second code in the row header associated with the location of each variable length field in the row. If a variable length field in a row is compressed then the code for that variable length field is the same for the next variable length field in the row or the end of the row. If a variable length field is not compressed then the code for that variable length field indicates the location of the value of the variable length field within the row.

In general, in another aspect, the invention features a method for reading a row from a table having a compressible variable length field. The method includes reading a first code from a first code field in the row. If the first code field contains a no-compression value, reading a second code from a second code field in the row. A value is read from a compressible variable length field located at a location given by the second code. Otherwise, if the first code contains a compression value the first code is used to read a value from a list of values and associated first codes stored in the table.

In general, in another aspect, the invention features a computer program, stored on a tangible storage medium, for use in coding a compressible variable length field in a database table. The table includes one or more rows. The program includes executable instructions that cause a computer to search for the value in a list of values for the compressible variable length field stored in the table. If the value is found in the list of values, the row is created in the table with a first code associated with the value and a second code associated with a location in the row but without the compressible field. Otherwise, the row is created in the table with the value stored in the compressible field, a first code indicating that the value is stored in the row, and a second code associated with the location of the value in the row.

In general, in another aspect, the invention features a database system including a massively parallel processing system including one or more nodes, a plurality of CPUs, each of the one or more nodes providing access to one or more CPUs, a plurality of data storage facilities each of the one or more CPUs providing access to one or more data storage facilities, and a table, the table being stored on one or more of the data storage facilities, the table including one or more rows. The database system includes a process for coding a compressible variable length field. The process includes searching for the value in a list of values for the compressible variable length field stored in the table. If the value is found in the list of values, the row in the table is created with a first code associated with the value and a second code associated with a location in the row but without the value. Otherwise, the row is created in the table with the value stored in the compressible field, a first code indicating that the value is stored in the row, and a second code associated with the location of the value in the row.

In general, in another aspect, the invention features a memory for storing data for access by a database system being executed on a data processing system including a data structure stored in the memory. The data structure resides within a table of the database system and includes a list of one or more values for a compressible variable length field and for each of the one or more values, an associated first code. The data structure also includes a code field for each row. The code field stores a second code associated with locations within the row.

Implementations of the invention may include one or more of the following. A data structure may be stored in the memory. The data structure may be within a table of the database system and may include a list of one or more values for a second compressible field and for each of the one or more values for the second compressible field, an associated first code. If the second compressible field is a variable length field the data structure may include a second code. The memory may further include a data structure stored in the memory. The data structure maybe within a table of the database system and include one or more rows, each row including a code field. If the code field in a row is set to a non-compression value, the row may include the compressible field. Otherwise, the row does not contain the compressible field. The data structure is not limited to one or two compressible fields.

### BRIEF DESCRIPTION OF THE DRAWINGS

FIG. 1 is a block diagram of a node of a database system.

FIG. 2 is a block diagram of a parsing engine.

FIG. 3 is a flow chart of a parser.

FIG. 4 is a representation of rows in a database table.

FIG. 5 is a representation of the prior art use of a look-up table.

FIG. 6 is a representation of a table with compressed rows.

FIG. 7 illustrates the relationship between the number of compressed values and the number of compress presence bits.

FIGS. 8 and 9 are flow charts.

### DETAILED DESCRIPTION

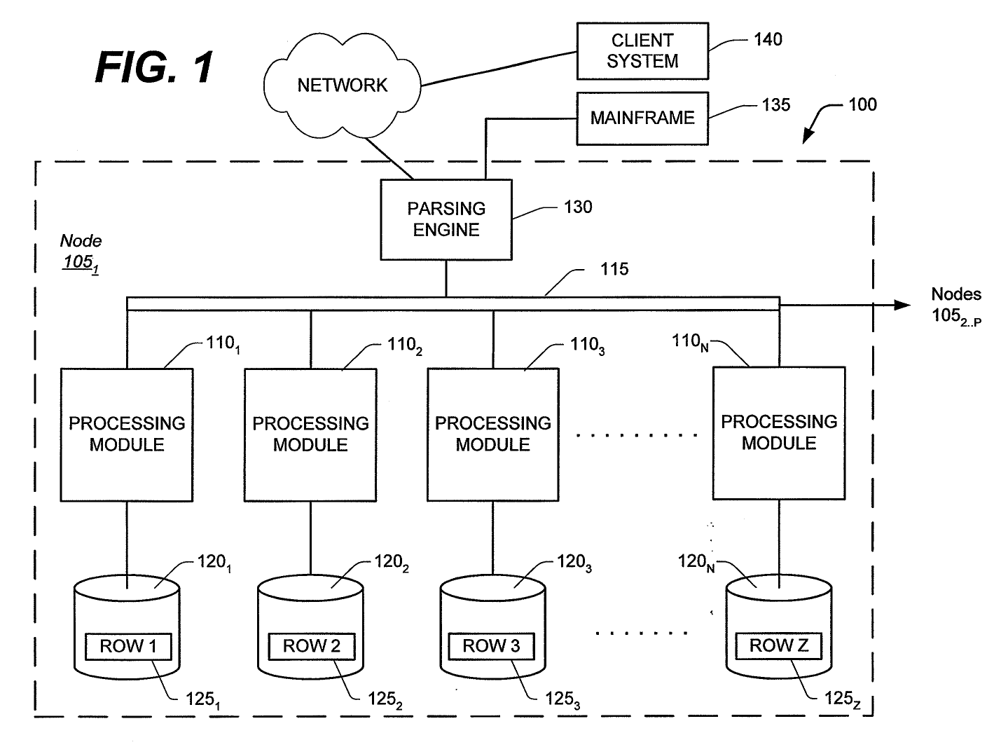

The technique for coding compressible database fields disclosed herein has particular application, but is not limited, to large databases that might contain many millions or billions of records managed by a database system (“DBS”) 100, such as a Teradata Active Data Warehousing System available from NCR Corporation. FIG. 1 shows a sample architecture for one node 105₁ of the DBS 100. The DBS node 105₁ includes one or more processing modules 110_{1 . . . N}. connected by a network 115, that manage the storage and retrieval of data in data-storage facilities 120_{1 . . . N}. Each of the processing modules 110_{1 . . . N} maybe one or more physical processors or each maybe a virtal processor, with one or more virtual processors running on one or more physical processors.

For the case in which one or more virtal processors are running on a single physical processor, the single physical processor swaps between the set of N virtual processors.

For the case in which N virtual processors are running on an M-processor node, the node's operating system schedules the N virtual processors to run on its set of M physical processors. If there are 4 virtal processors and 4 physical processors, then typically each virtal processor would run on its own physical processor. If there are 8 virtual processors and 4 physical processors, the operating system would schedule the 8 virtal processors against the 4 physical processors, in which case swapping of the virtual processors would occur.

Each of the processing modules 110_{1 . . . N} manages a portion of a database that is stored in a corresponding one of the data-storage facilities 120_{1 . . . N}. Each of the data-storage facilities 120_{1 . . . N} includes one or more disk drives. The DBS may include multiple nodes 105_{2 . . . P} in addition to the illustrated node 105₁, connected by extending the network 115.

The system stores data in one or more tables in the data-storage facilities 120_{1 . . . N}. The rows 125_{1 . . . Z} of the tables are stored across multiple data-storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data-storage facilities 120_{1 . . . N} in response to queries received from a user at a mainframe 135 or a client computer 140. The DBS 100 usually receives queries and commands to build tables in a standard format, such as SQL.

In one implementation, the rows 125_{1 . . . Z} are distributed across the data-storage facilities 120_{1 . . . N} by the parsing engine 130 in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket”. The hash buckets are assigned to data-storage facilities 120_{1 . . . N} and associated processing modules 110_{1 . . . N} by a hash bucket map. The characteristics of the columns chosen for the primary index determine how evenly the rows are distributed.

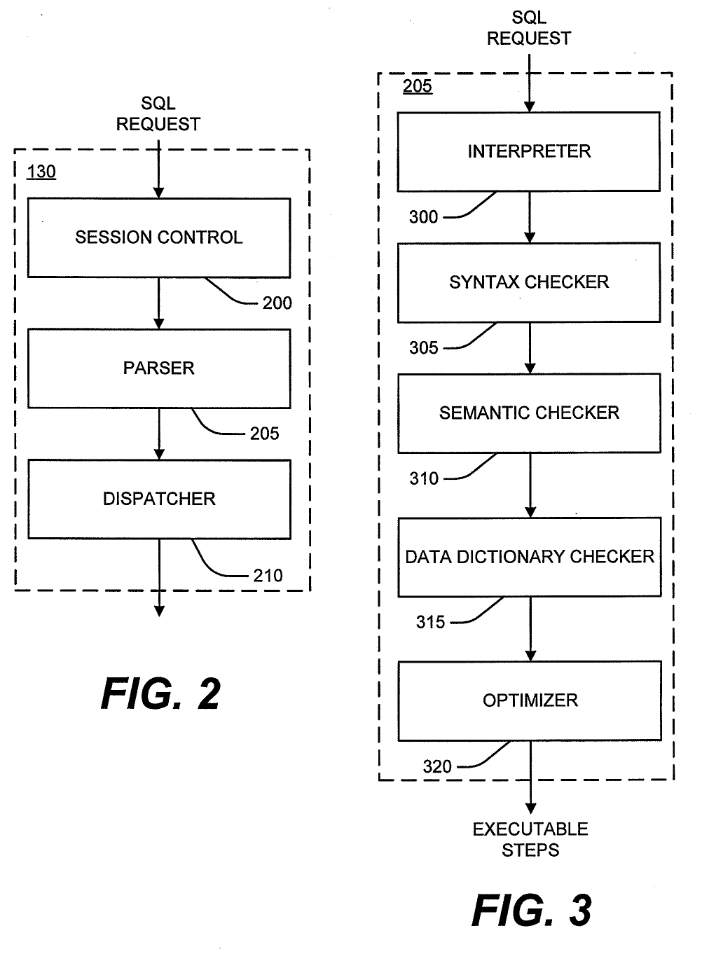

In one example system, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

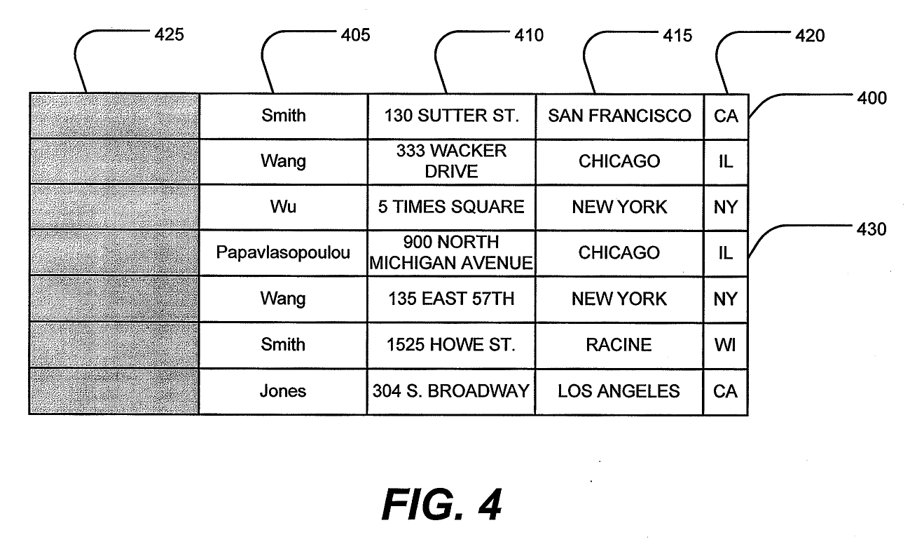

Once the session control 200 allows a session to begin, a user may submit a SQL request, which is routed to the parser 205. As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and that the user has the authority to perform the request (block 315). Finally, the parser 205 runs an optimizer (block 320), which develops the least expensive plan to perform the request.

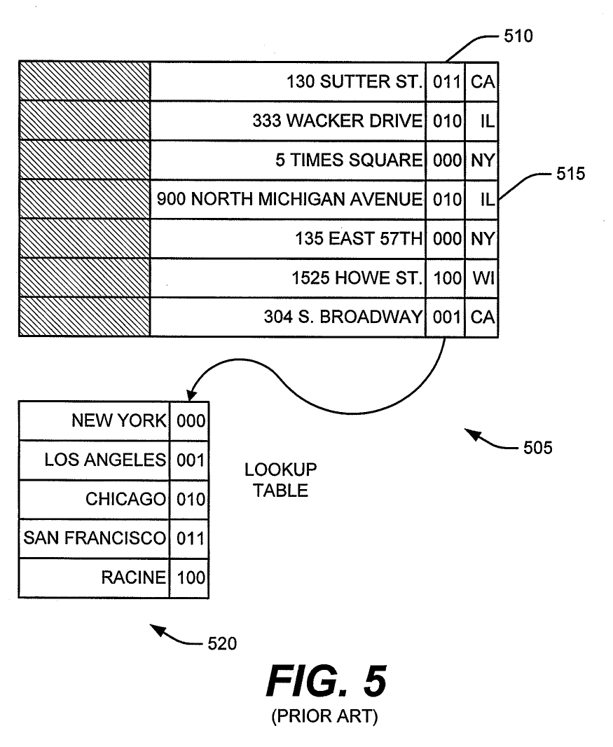

An example of a table with a compressible field, illustrated in FIG. 4, includes rows, e.g. 400, and fields, including a LastName field 405, a StreetAddress field 410, a City field 415, a State field 420, and other fields 425, such as indices, first names, etc. As can be seen in FIG. 4, the LastName field has multiple instances of “Smith,” and “Wang”. The LastName field can contain names that can be very short for instance, “Wu”, the LastName field can also contain very long names, for instance, “Papavlasopoulou.” In order to accommodate a last name field where the last names may be of widely different differing lengths, a data type such as VarChar is used to avoid wasting space. The LastName field in FIG. 4 is a candidate for a compressible field because it can be compressed by representing each of the very popular names, for example “Smith” and “Wang”, with a code that corresponds to that value. As can also be seen in FIG. 4, the fixed length City field has multiple instances of “New York,” and “Chicago.” Such a field is a compressible field because it can be compressed by representing each value in the field with a code that corresponds to the value.

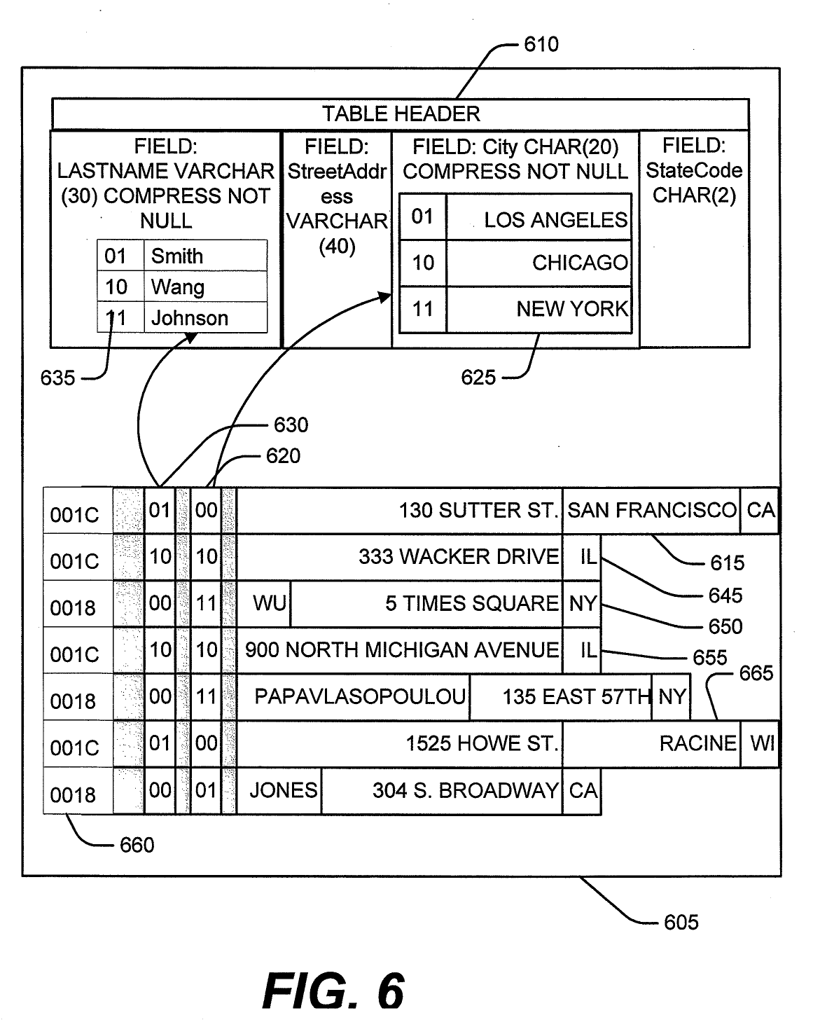

In a typical prior art system, an example of which is shown in FIG. 5, the compressible fixed length field in a table 505 is replaced by a code field 510. The code field includes a code, such as the binary bit sequence shown in FIG. 5, that represents the compressible field value associated with that row. For example, the value “Chicago”, shown in row 430 (FIG. 4), is represented by the binary code “010” in row 515 (FIG. 5).

In some existing systems, a look-up table 520 is provided to translate the code to the compressible field value. In relational databases using SQL, the look-up table 520 is frequently joined with the original table 505 during execution of queries that select information from the compressible field.

Instead of using look-up tables, some existing systems use a SQL CASE statement within each application that uses the compressible field. The SQL CASE statement provides branching on each of the codes associated with the compressible field's values.

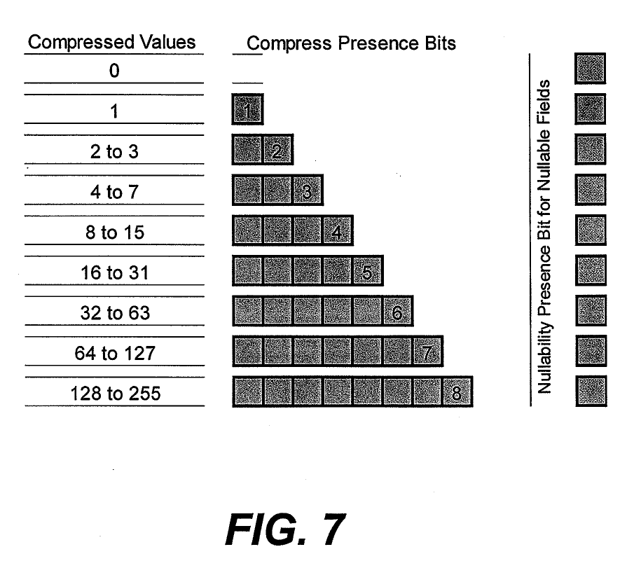

In one example of a database system for coding compressible fields, a database table 605, illustrated in FIG. 6, includes a table header 610 and one or more rows, e.g. 615, each of which includes one or more fields. In the example, table 605 contains generally the same information as the table shown in FIG. 4. New code fields 620 and 630 have been added to each of the rows in table 605. Typically, the code fields are presence bit fields included in each row header. The code fields 620 and 630 eliminate the compressible field (such as the City field 415 and LastName field 405 shown in FIG. 4) for some or all of the values, included in a list of values 625 and 635, that field can contain. If the value for the field is not included in the list of values 625 and 635, the value is stored in the compressible field and the code field 620 is set to a particular value that indicates the presence of the value in the compressible field.

For rows with compressible variable length fields such as the LastName field in FIG. 6, a second code is provided in the row header associated with the location of the value within the row. In the example shown in FIG. 6 the second code is a 2-byte offset value shown in column 660. When a value in a compressible variable length field in a row is not compressed the second code indicates the position of the value in the row. If the value in a row is a compressed value the second code indicates the position of the next variable length field in that row or the end of the row.

In the example in FIG. 6, the second code contains the value 0018 for rows that do not contain a compressed value in the LastName field, for example rows 650 and 655. In rows that contain a compressed value in the LastName field the second code contains the value 001C, being the location of the next variable length field. In the example shown in FIG. 6 the next variable length field after the LastName field is the street address field. If there were no variable length fields following the LastName field then the second code would indicate the end of the row when the LastName field contained a compressed value.

In one example, the lists of values 625 and 635 take the form of look-up tables that reside in the table header 610. It will be understood that the lists of values 625 and 635 can take other forms, such as indexed lists or hashed lists, and that, while the lists of values reside inside the table 605, they may reside outside the table header 610. The lists of values 625 and 635 each correlate a set of codes with a set of values for the compressible field. In the example shown in FIG. 6, the compressible variable length field is the LastName field, the values in the list of values 635 are “Smith,” “Wang,” and “Johnson,” and the codes correlated to these values are “01,” “10,” and “11,” respectively.

The LastName first code field 630 in each row is set to the code that corresponds to the value that would have been stored in the LastName field in the row had that field not been compressed. For example, row 640 includes the code “01” in its LastName first code field 630. The code “01” corresponds to “Smith” as can be seen by referring to a list of values 635. The LastName field does not exist in row 640.

If a LastName field value does not appear in the list of values, such as “Wu” in row 650 and Papavlasopoulou in row 655, the LastName field is included in the row and the LastName first code field is set to indicate that the LastName field exists in this row. In the example in FIG. 6, this is indicated by setting the LastName first code field to “00.”

As well as a first code field the database includes a second code field for compressible variable length fields. The second code field provides an indication of the location of the variable length field within the row. If the value in the compressible variable length field is compressed the second code field provides an indication of the next variable length field in the row. If the value in the variable length field is not compressed, the second code value provides an indication of the location of the variable length field in the row. In the example in FIG. 6 second code field 660 contains code 0018 when the variable length fields are not compressed and 001C when the variable length fields are compressed such as row 640.

In the example shown in FIG. 6, the City field is a fixed length compressible field. The values in the list of values are “Los Angeles,” “Chicago,” and “New York,” and the codes correlated to these values are “01,” “10,” and “11,” respectively.

The CityCode field 620 in each of the rows is set to the code that corresponds to the value that would have been stored in the City field in the row had that field not been compressed. For example, row 630, which corresponds to row 430 in the table shown in FIG. 4, includes the code “10” in its CityCode field. This code correlates to the value “Chicago,” as can be seen by referring to the list of values 625. The City field does not exist in row 655.

If the City field value does not appear in the list of values, such as “San Francisco” in row 640 and “Racine” in row 665, the City field is included in the row and the CityCode row is set to indicate that the City field exists in this row. In the example shown in FIG. 6, this is indicated by setting the CityCode field to “00.”

This compression technique eliminates the compressible field entirely from rows that have values for the compressed field that are included in the list of values. The overhead cost of the compression is the list of values and the first and second code fields.

Further, multiple fixed length and variable length fields can be compressed using this same technique. Generally, each compressible variable length field will have its own list of values and its own first and second code fields. Each compressible fixed length field will have its own list of values and it sown first code field. The length of the code fields for each of the compressible fields is independent of the lengths of the code fields for other compressible fields within the same row. The length of a particular code field is the same in all rows.

Using this compression technique, more than one variable length field may be compressed in a table. In the example shown in FIG. 6, the conversion technique is applied to a variable length field and a fixed length field. The compression technique can, however, be applied to any number of compressible variable length and fixed length fields in a database or table.

Situations may exist in which two compressible fields will share a single list of values. For example, a table with one field for a person's residence address and another field for the person's mailing address could share the same list of values. It may also be advantageous in such situations to add another code field to indicate whether the two compressible columns have the same value and therefore the same code. In the residence/mailing address example described above, this technique would eliminate one of the codes for all but the unusual situations in which a person receives mail in a different city from where the person resides. The cost could be as low as a single bit in each row.

This compression technique is lossless because, although data is compacted, no information is lost in the process. The granularity of this compression technique is to the individual field of a row. Furthermore, field compression allows compression to be independently optimized for the data domain of each field.

This technique also allows database operations to be performed directly on the compressed fields without the need to reconstruct a decompressed row or field.

In one example system, up to 255 distinct values in each field can be compressed out of the row body. If the field is nullable, then NULLs are also compressed. The best candidates for compression are the most frequently occurring values in each field.

Variable-length or fixed-length fields that are not part of the primary index are candidates for compression under this technique. This includes fields that are used in a secondary index. The following data types are compressible. The native number of bytes used in the NCR Teradata system referenced above for each data type is indicated in parentheses.

| | |
|---|---|
| VARGRAPHIC | (N) (N < 256) |
| VARCHAR | (N) (N < 256) |
| LONG VARCHAR | (N) (N < 64k) |
| VAR BYTE | (N) (N < 256) |
| DATE | (4) |
| CHAR | (N) (N < 256) |
| BYTEINT | (1) |
| SMALLINT | (2) |
| INTEGER | (4) |
| FLOAT/REAL | (8) |
| DOUBLE | (8) |
| DECIMAL | (1, 2, 4, or 8) |
| BYTE | (N) (N < 256) |

When a field has frequently occurring values, it can be highly compressed. Some examples include the following:

NULLs

Zeros

Default values

Flags

Spaces

Binary indicators (e.g., T/F)

Age (in years)

Gender

Education Level

Number of children

Credit card type

State, Territory, County, City, Country

Automobile Make

Reason

Status

Category

Codes

This compression technique is completely transparent to applications, ETL (extraction, transforming, and loading of data), queries, and views. Compression can be specified when tables are created or columns are added to an existing table. For example, here is the syntax for compressing common last names and several populous cities:

```
CREATE TABLE Properties (
  LastName VARCHAR (30) COMPRESS(
      ‘Smith’,
      ‘Wang’,
      ‘Johnson’),
  StreetAddress VARCHAR(40),
  City CHAR(20) COMPRESS (
    ‘Chicago’,
    ‘Los Angeles’,
    ‘New York’),
  StateCode CHAR(2)
);
```

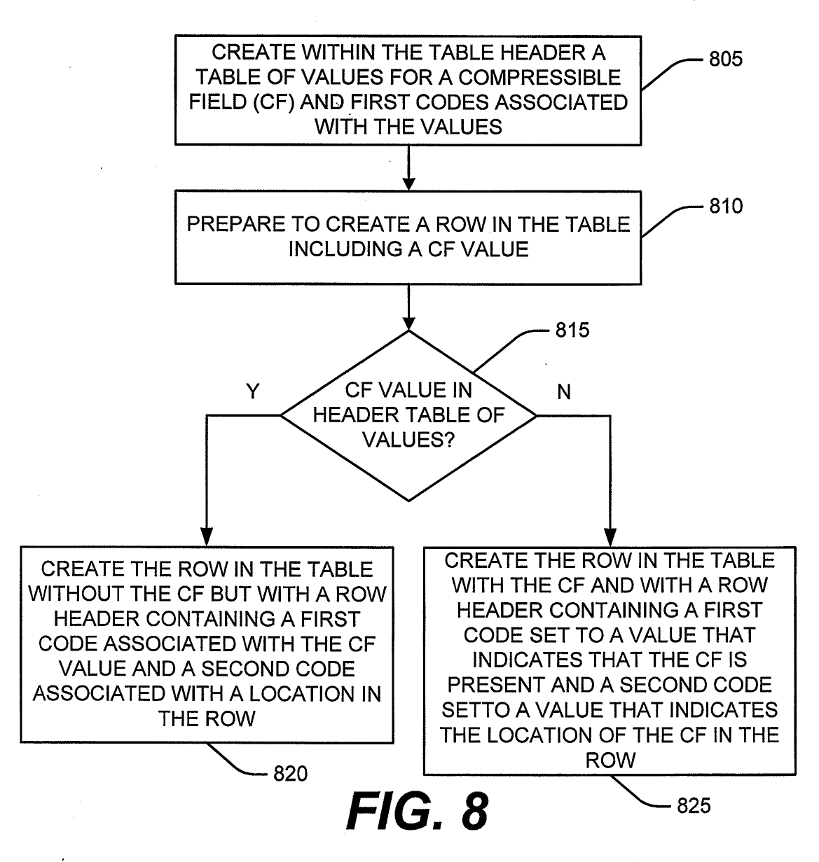

There is a tradeoff associated with the number of values to include in the list of values. As the number of values in the list of values increases, the number of bits that must be stored in each row to code those values also increases, as shown in FIG. 7. One value requires one bit (also called a “Compress Presence Bit”) in the code field. Two to three values require two bits, four to seven values require three bits, and so on. Generally, the code field will have the number of bits required for a binary expression of the number of values in the list of values.

The number of values to include in the list of values also depends on the percentage of rows that will be compressed. Each additional value added to the list of values increases the number of rows that will be compressed and therefore the amount of compression achieved. At the same time, however, increasing the list of values may increase the overhead associated with the compression technique as discussed above. In general up to T values can be stored in the list of values in the table header where T is a number determined by the amount of storage space available and the maximum allowable length of compressible values.

There is a tradeoff associated with the length of the values to be compressed in a variable length field included in the list of values. In some instances a variable length field can be as large as 64,000 bytes. Storing variables of this length in a list of values decreases the amount of space available for storing other information in the same location. For example, if a list of values stored in a table header has a limit of 128,000 bytes, storing values of variable length fields up to 64,000 bytes in the table header can lead to overflow in the table header. To avoid this overflow problem a variable defining the maximum allowable length of a compression value can be set at table creation or in an ALTER TABLE statement. Once the maximum compression length variable is set, the length is used to allocate space for each compress value specified for a variable length column. For example, the maximum compression length variable is used to allocate space m the table header for each compress value. A compressed value size will not be allowed to exceed the specified length. For example, in the table given in FIG. 6, the LastName column can be defined as VarChar(30), to ensure that long names are accommodated. The maximum compression length variable can be set to 10, so that popular names like “Smith” or “Wang” will qualify as compression values and can be stored, and long names like “Papavlaspoulou” will not be allowed to be compressed.

The list of compressible values can be specified at table creation or after table creation whenever the table is emptied or loaded with data. For example if a table is to be loaded with data including last name data lists of common last names that will appear in the data can be specified before the table is created. Alternatively these lists can be specified after the table is created and before data is loaded into a table. Values such as null values can be compressed automatically. Other values to be compressed are specified. If a table has already been created and it is desired to compress a column that previously has not been compressible the status of the column can be changed using an alter table statement and a list of values for compression can be specified.

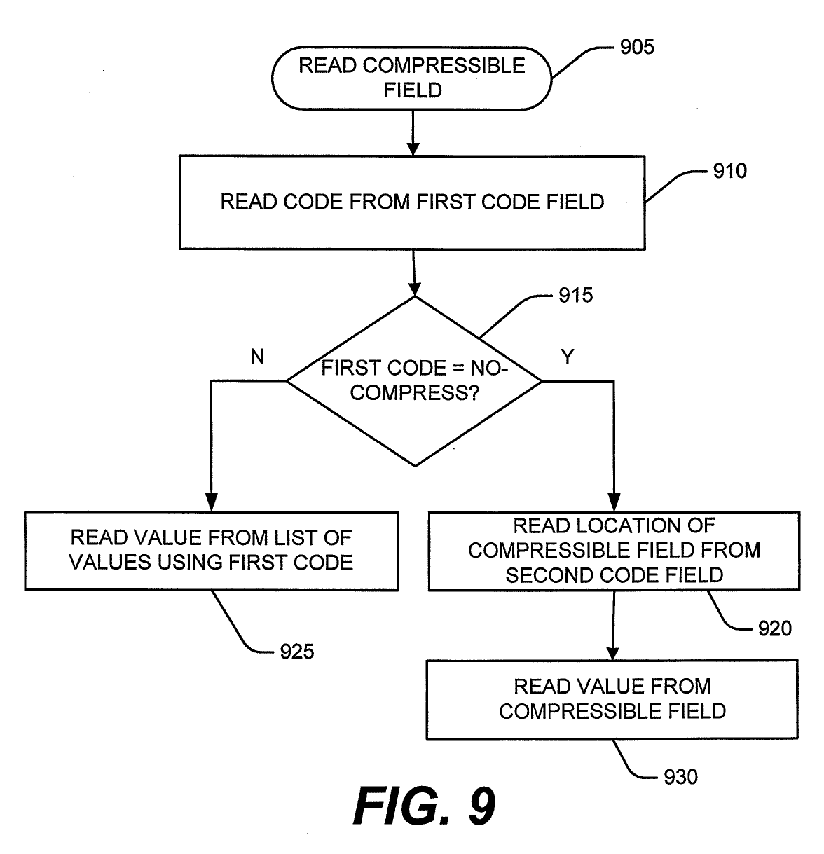

To perform compression, as shown in FIG. 8, the system creates within the header of the table to be compressed a table of values for a compressible variable length field (CF) and first codes associated with the values (block 805), similar to header 635 shown in FIG. 6. The system also creates second codes associated with locations in the table rows. The second codes are stored in the row headers of each row. When the system prepares to create a row in the table including a CF value (block 810), the system determines if the CF is in the header table of values (block 815). If the CF is in the header table of values, the system creates the row in the table without the CF value but with the first code associated with that value in the first code field (block 820). The system also sets the second code for that field to the location of the next variable length column or the end of the row. Otherwise, the system creates the row in the table with the CF set to the CF value and with the first code field set to a value that indicates that the CF is present and set (block 825), and the second code set to a value that indicates the location of the CF in that row.

When it is desired to read a value from the compressible field (block 905) in a row, as shown in FIG. 9, the system reads the first code from the row's first code field (which may be in the row header) (block 910). If the first code is set to a value that indicates that the compressible field was not compressed in this row (block 915), the system reads second code from the row's second code field (which may be in the row header) (block 920). The system uses the second code to find the location of the compressible field in the row and reads the value from the compressible field in that location (block 930). Otherwise, the system uses the first code to read a value from the list of values (block 925).

The text above describes one or more specific embodiments of a broader invention. The invention also is carried out in a variety of alternative embodiments and thus is not limited to those described here. For example, while the invention has been described here in terms of a DBMS that uses a massively parallel processing (MPP) architecture, other types of database systems, including those that use a symmetric multiprocessing (SMP) architecture, are also useful in carrying out the invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A method for coding a compressible variable length field in a row to be added to a database table, the row having a value to be stored in the compressible variable length field, the method comprising:
searching for the value in a list of values for the compressible variable length field stored in the table;
if the value is found in the list of values:
creating the row in the table with:
a first code associated with the value,
a second code associated with a location in the row,
but without the compressible variable length field,
otherwise,
creating the row in the table with:
the value stored in the compressible variable length field,
a first code indicating that the value is stored in the row, and
a second code associated with the location of the value in the row.

2. The method of claim 1 wherein searching for the value comprises
searching for the value in a list of values for the compressible variable length field stored in the table header.

3. The method of claim 1 further comprising
creating the list of values for the compressible variable length field within the table; and
associating a first code with each of the values in the list of values.

4. The method of claim 1 wherein the list of values includes T values and associating a first code with each of the values in the list of values comprises assigning a unique first code to each of the T values.

5. The method of claim 4 wherein the size of each of the T values is less than a preset size.

6. A method for reading a row from a table having a compressible variable length field, the method comprising
reading a first code from a first code field in the row,
if the first code field has a no-compression value,
reading a second code from a second code field in the row,
reading a value from a compressible field located at a location associated with the second code field
otherwise,
using the first code to read a value from a list of values and associated codes stored in the table.

7. A computer program, stored on a tangible storage medium, for use in coding a compressible variable length field in a database table, the table including one or more rows, the program including executable instructions that cause a computer to:
search for a value in a list of values for the compressible variable length field stored in the table;
if the value is found in the list of values:
create the row in the table with:
a first code associated with the value,
a second code associated with a location in the row,
but without the compressible variable length field,
otherwise,
create the row in the table with:
the value stored in the compressible variable length field,
a first code indicating that the value is stored in the row, and
a second code associated with the location of the compressible variable length field in the row.

8. The computer program of claim 7 where, when searching for the value, the computer searches for the value in a list of values for the compressible variable length field stored in the table header.

9. The computer program of claim 7 further comprising executable instructions that cause a computer to create the list of values for the compressible variable length field within the table; and associate a first code with each of the values in the list of values.

10. The method of claim 7 wherein the list of values includes T values and where, when associating a first code with each of the values in the list of values, the computer assigns a unique first code to each of the T values.

11. The method of claim 9 wherein the size of each of the T values is less than a preset size.

12. A database system including:
a massively parallel processing system including one or more nodes;
a plurality of CPUs, each of the one or more nodes providing access to one or more CPUs;
a plurality of data storage facilities each of the one or more CPUs providing access to one or more data storage facilities;
a table, the table being stored on one or more of the data storage facilities, the table including one or more rows;
a process for coding a compressible variable length field, the process including:
searching for the value in a list of values for the compressible variable length field stored in the table;
if the value is found in the list of values:
creating the row in the table with:
a first code associated with the value,
a second code associated with a location in the row,
but without the value,
otherwise,
creating the row in the table with:
the value stored in the compressible variable length field,
a first code indicating that the value is stored in the row, and
a second code associated with the location of the value in the row.

13. A memory for storing data for access by a database system being executed on a data processing system, comprising:
a data structure stored in the memory, the data structure within a table of the database system including:
a list of one or more values for a compressible variable length field,
for each of the one or more values, an associated first code; and
for each of the one or more fields an associated second code.

14. The memory of claim 11 wherein the size of each value in the list of values is less than a preset size.

15. The memory of claim 13, further comprising
a data structure stored in the memory, the data structure within a table of the database system including:
a list of one or more values for a second compressible field; and
for each of the one or more values for the second compressible field, an associated first code and an associated second code.

16. The memory of claim 11, further comprising
a data structure stored in the memory, the data structure within a table of the database system including:
one or more rows, each row comprising
a first code field;
a second code field;
if the first code field is set to a non-compression value,
the compressible variable length field stored in a location associated with the second code;
otherwise,
the row does not contain the compressible variable length field.
